(19) United States
(12) Patent Application Publication
(10) Pub. No.: US 2023/0076559 A1
(43) Pub. Date: Mar. 9, 2023

(54) EXPLAINABLE ARTIFICIAL INTELLIGENCE BASED DECISIONING MANAGEMENT SYSTEM AND METHOD FOR PROCESSING FINANCIAL TRANSACTIONS

(71) Applicant: Lithasa Technologies Pvt Ltd, Mumbai (IN)

(72) Inventors: Vinay Kumar Sankarapu, Mumbai (IN); Deekshith Marla, Mumbai (IN); Shashwat Antony, RAIPUR (IN)

(21) Appl. No.: 17/527,134

(22) Filed: Nov. 15, 2021

(30) Foreign Application Priority Data
Sep. 7, 2021 (IN) 202121040459

(51) Int. Cl. G06Q 40/08; G06N 3/08; G06Q 40/02

(52) U.S. Cl. CPC G06Q 40/08; G06N 3/084; G06Q 40/025

(57) ABSTRACT

An explainable artificial intelligence based decisioning management method and system for processing financial transaction is disclosed. The method includes receiving a request for performing a financial transaction from applicant and from data sources. The method further includes performing a data sufficiency check using one or more neural network on the request by validating the request of the applicant with one or more external data sources. Further, the method includes generating a decision for the received request using neural network model if the data sufficiency check is successful. Additionally, the method includes validating the decision by reverse calculating, through the neural layers of the neural network model, an importance weightage distribution across each of the neural nodes. Also, the method includes generating a case assessment report for the generated decision based on the validation. Furthermore, the method includes performing the financial transaction with the applicant in response to the received request based on the generated case assessment report.

### EARLIEST PRIORITY DATE

This application claims priority from a complete patent application filed in India having Patent Application No. 202121040459, filed on Sep. 7, 2021, and titled “EXPLAINABLE ARTIFICIAL INTELLIGENCE BASED DECISIONING MANAGEMENT SYSTEM AND METHOD FOR PROCESSING FINANCIAL TRANSACTIONS”.

### FIELD OF INVENTION

Embodiments of the present disclosure relate to decision making systems and more particularly to an explainable artificial intelligence based decisioning management system and method for processing financial transactions.

### BACKGROUND

Typically, in any financial transaction, the decision-making process of whether or not to perform a financial transaction such as underwriting process including grant a loan, a mortgage, grant of an insurance, settle an insurance claim and the like, is often partially subjective with some degree of uncertainty. This results in an unacceptably high risk that the financial transaction may be defaulted on. Conventionally, the decision-making process for an ‘application’ to complete the financial transaction involves multiple steps and multiple cognitive and logical steps. These multiple steps are form-based processes which involves processing information given by the applicant, verifying the information, creating an assessment and finally completing the financial transaction for example, by granting the loan applied for, or issuing the insurance policy or claim and the like. These multiple steps involve measuring risks associated with the application, such as profile risk, transactional risk, health risk, financial risk and the like. Such risks can affect payment structure (in terms of amount and timing) paid by the applicant, e.g., the higher the risk, the higher the overall payment. A final decision to accept or reject the application for the financial transaction may also be part of this risk calculation, as the risks above a certain tolerance level set by the financial company may simply be rejected.

Conventional approaches use neural networks based on artificial intelligence for the decision-making process. However, such neural networks based on artificial intelligence fail to provide reasoning behind arriving at the final decision. The final decisions are represented using heat-maps or distribution graphs based on node activation. However, there are currently no mechanisms to track and validate the final decision outputted by such neural networks based on artificial intelligence. These existing methods fail to represent the impact of each node within the neural networks over the final decision. Specifically, such existing methods are unable to differentiate between the impact of the nodes versus internal network biases.

Other conventional approaches such as Integrated Gradients and Shapley values calculate feature importance from deep learning models. However, both of these conventional approaches have caveats and give approximate values. For example, integrated Gradients depends on a baseline sample which needs to be constructed for the dataset and altered as the dataset shifts. This is extremely difficult for a high dimensional dataset. Similarly, Shapley Values are calculated on a sample set selected from the complete data set for compute optimization. This makes those values highly dependent on the selection of data.

Hence, there is a need for an explainable artificial intelligence based decisioning management method and system for processing financial transactions in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, an explainable artificial intelligence based decisioning management system for processing financial transactions is disclosed. The explainable artificial intelligence based decisioning system includes one or more hardware processors and a memory coupled to the one or more hardware processors. The memory includes a plurality of subsystems in the form of programmable instructions executable by the one or more hardware processors. The plurality of subsystems includes a request handler module configured for receiving a request for performing a financial transaction from an applicant and from one or more data sources. The request comprises application information of the applicant, financial information, health information, activity information, sourcing information of the applicant. The plurality of subsystems further includes a data sufficiency validation module configured for performing a data sufficiency using one or more neural network on the received request by validating the request using one or more neural networks. Furthermore, the plurality of subsystems includes a decision generator module configured for generating a decision for the received request using a neural network model if the data sufficiency check is successful. The decision comprises at least one of an acceptance decision of the request, customization decision of the request and a rejection decision of the request. The neural network model comprises one or more neural layers comprising neural nodes representing an analysis of the application information of the applicant and wherein each of the neural nodes are assigned a weightage based on training data.

Further, the plurality of subsystems includes a neural network explainable module configured for validating the generated decision by reverse calculating, through the one or more neural layers of the neural network model, the importance weightage distribution across each of the neural nodes towards the data features considered in the neural network. Also, the plurality of subsystem includes a case assessment report generation module configured for generating a case assessment report for the generated decision based on the validation, wherein the case assessment report comprises explainable reasons for arriving at the decision by the neural network model, the importance weightage of each data feature considered and the impact of each the neural nodes on arriving at the decision and similar past transactions. Furthermore, the plurality of subsystem includes a financial transaction performer module configured for performing the financial transaction with the applicant in response to the received request based on the generated case assessment report.

In accordance with another embodiment of the present disclosure, an explainable artificial intelligence based decisioning management method for processing financial transactions is disclosed. The method includes receiving a request for performing a financial transaction from an applicant and from one or more data sources. The request comprises personal information, financial information, health information, activity information, sourcing information and likes of the applicant. The method further includes performing a data sufficiency check using one or more neural network on the received request by validating the request of the applicant with trained neural network models. Further, the method includes generating a decision for the received request using one or more neural network models if the data sufficiency check is successful. The decision comprises at least one of an acceptance decision of the request and customization decision and a rejection decision of the request. The neural network model comprises one or more neural layers comprising neural nodes representing an analysis of the application information of the applicant and wherein each of the neural nodes are assigned a weightage. Additionally, the method includes validating the generated decision by calculating, through the one or more neural layers of the neural network model, an importance weightage distribution across each of the neural nodes towards the data features considered in the neural network. Also, the method includes generating a case assessment report for the generated decision based on the validation. The case assessment report comprises explainable reasons for arriving at the decision by the neural network model, the importance weightage of each data feature considered and impact of each the neural nodes on arriving at the decision and similar past transactions. Furthermore, the method includes performing the financial transaction with the applicant in response to the received request based on the generated case assessment report.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary computing environment for processing financial transactions, in accordance with an embodiment of the present disclosure;

FIG. 2 is a block diagram illustrating an exemplary computing system, such as those shown in FIG. 1, capable of processing financial transactions, in accordance with an embodiment of the present disclosure;

FIG. 3 is a process flow diagram illustrating an exemplary method for processing financial transactions, in accordance with an embodiment of the present disclosure;

FIG. 4 is a block diagram illustrating an exemplary process for processing financial transactions, in accordance with an embodiment of the present disclosure;

FIG. 5 is a block diagram illustrating a detailed component overview of the exemplary computing system, such as those shown in FIG. 2, capable of processing financial transactions, in accordance with an embodiment of the present disclosure;

FIG. 6 is a block diagram illustrating various components of an exemplary data collection module, such as those shown in FIG. 5, in accordance with an embodiment of the present disclosure;

FIG. 7 is a block diagram illustrating an exemplary questions model, such as those shown in FIG. 6, in accordance with an embodiment of the present disclosure;

FIG. 8 is a block diagram illustrating various components of an exemplary decision generator module, such as those shown in FIG. 5, in accordance with an embodiment of the present disclosure;

FIG. 9 is a block diagram illustrating a Neural Network Explainable Module and a case assessment report generation module, such as those shown in FIG. 5, in accordance with an embodiment of the present disclosure;

FIG. 10 is a block diagram illustrating a feedback module, such as those shown in FIG. 4 and FIG. 5, in accordance with an embodiment of the present disclosure;

FIG. 11 is a block diagram illustrating a feedback module, such as those shown in FIG. 4 and FIG. 5, in accordance with another embodiment of the present disclosure;

FIG. 12 is a schematic representation of an exemplary neural network, in accordance with an embodiment of the present disclosure; and

FIG. 13 is a schematic representation of an exemplary neural network explainable module output, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module may comprise dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

Throughout this document, the terms browser and browser application may be used interchangeably to mean the same thing. In some aspects, the terms web application and web app may be used interchangeably to refer to an application, including metadata, that is installed in a browser application. In some aspects, the terms web application and web app may be used interchangeably to refer to a website and/or application to which access is provided over a network (e.g., the Internet) under a specific profile (e.g., a website that provides email service to an applicant under a specific profile). The terms extension application, web extension, web extension application, extension app and extension may be used interchangeably to refer to a bundle of files that are installed in the browser application to add functionality to the browser application. In some aspects, the term application, when used by itself without modifiers, may be used to refer to, but is not limited to, a web application and/or an extension application that is installed or is to be installed in the browser application.

Embodiments of the present disclosure disclose an artificial intelligence (AI) based platform with tools, AI algorithms and features that can act on any financial transaction that needs any kind of underwriting or due diligence for processing. The embodiment of the present disclosure provides an explainable artificial intelligence based decisioning management method and system for processing financial transaction. The present system comprises an AI module which dynamically requests and collects information required for processing an application through intelligent interactions as predicted by one or more neural networks. The present system then passes on this collected information to another neural network module that takes a judgmental call such as an expert on sufficiency of the collected information, requests for additional information and then makes a decision based on past learnings. Such cognitive functionality is created by building a complex mesh of neural networks in a unique manner. While the AI module takes a verdict using learning aggregated among millions of neurons, it becomes challenging to explain the functioning of the present system. Hence, a new framework called ‘Neural Network Explainable Module is designed which explains the functioning of the AI module that uses neural networks. This new framework debugs feature wise importance weightage by back tracing the feature importance weightage across each layer. The present system uses this explanations to generate the functionality of AI in simple explainable English and to assess the bias in the data. To have more control on the AI module and to mitigate bias, the present system defines functional guidelines wherever required. Such guidelines can be defined manually or generated by an AI automatically. The present system runs these guidelines in a simulated test environment and shares the performance feedback to the AI defining guidelines. Post completing the transaction, the present system allows to share feedback in real time through ‘reverse feed’ feature. This feedback information is aggregated over time and the present system can initiate self-retraining or upon request from the applicant. Retraining can be initiated on all the neural networks used in the process or individually. Post completing the retraining, the present system stores the learnings and runs on predefined or dynamic test data and presents the results for the applicant to override the new learnings. Thereby, the present system can function fully autonomously from end to end.

This generic framework is applicable for any financial transactions that involves experts to perform on transactional underwriting process across financial products such as insurance, loans, mortgage and the like.

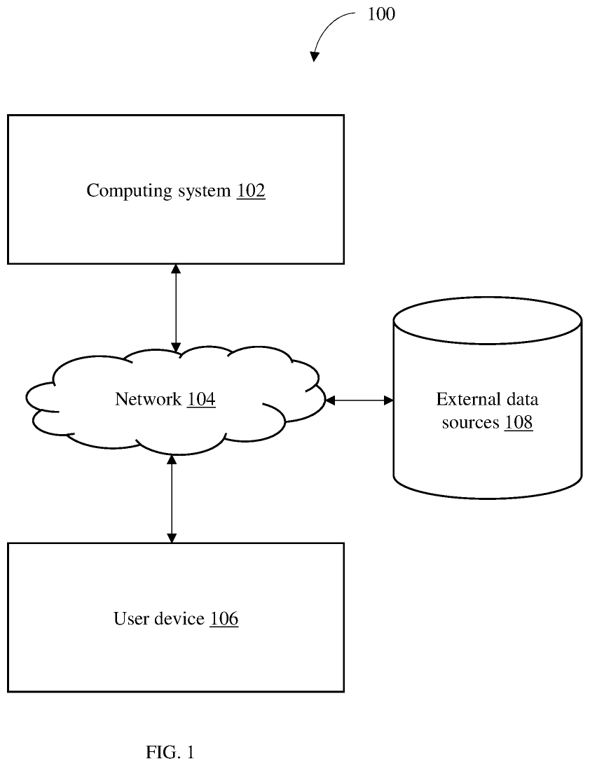

Referring now to the drawings, and more particularly to FIGS. 1 through 13, where similar reference characters denote corresponding features consistently throughout the figures, there are shown preferred embodiments and these embodiments are described in the context of the following exemplary system and/or method.

FIG. 1 is a block diagram illustrating an exemplary computing environment 100 for processing financial transaction, in accordance with an embodiment of the present disclosure. According to FIG. 1, the computing environment 100 comprises a computing system 102 which is capable of processing financial transaction. The computing system 102 is connected to user device 106 via a network 104 (e.g., Internet). In one specific embodiment, the networks 104 may include, but not limited to, an internet connection, a wireless fidelity (WI-FI) and the like. Although, FIG. 1 illustrates the computing system 102 connected to one user device 106, one skilled in the art can envision that the computing system 102 can be connected to several user devices located at different locations via the network 104. The computing system 102 is also connected to one or more external data sources 108 via the network 104. The computing system 102 may be a cloud computing system or a remote server.

The user devices 106 can be a laptop computer, a desktop computer, a tablet computer, a smartphone and the like. The user device 106 can access software applications via a web browser. The user device 106 includes a user interface for managing the software applications for performing financial transactions. The software application may be a web application including one or more web pages.

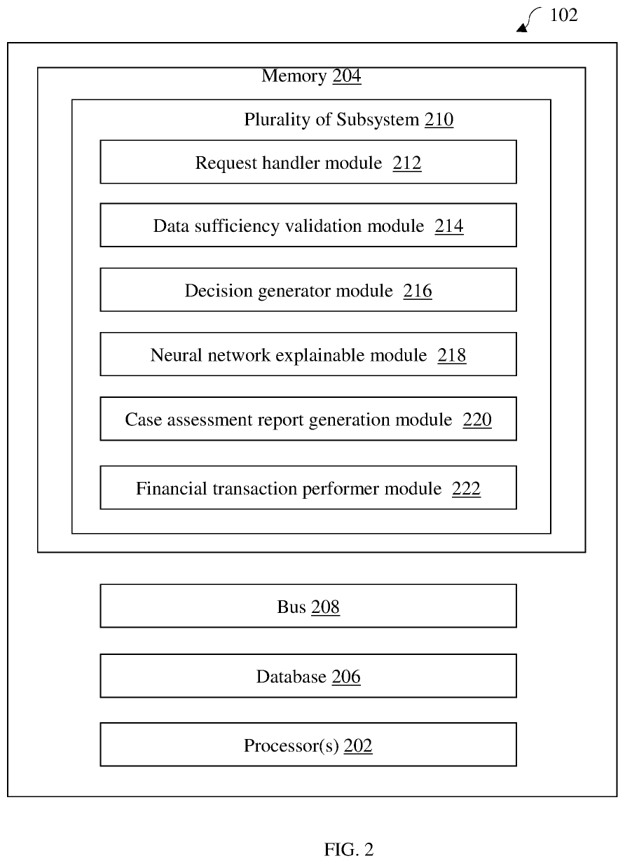

The computing system 102 includes an interface, a server including hardware assets and an operating system (OS), a network interface, and application program interfaces (APIs). The interface enables communication between the server and the user device 106. As used herein, “computing environment” 100 refers to a processing environment comprising configurable computing physical and logical assets, for example, networks, servers, storage, applications, services, etc., and data distributed over the platform. The computing environment 100 provides on-demand network access to a shared pool of the configurable computing physical and logical assets. The server may include one or more servers on which the OS is installed. The servers may comprise one or more processors, one or more storage devices, such as, memory units, for storing data and machine-readable instructions for example, applications and application programming interfaces (APIs), and other peripherals required for providing cloud computing functionality. A detailed view of the computing system 102 is provided in FIG. 2.

The computing system 102 comprises a plurality of subsystems 112 configured for managing the financial transactions. In an embodiment, the computing system 102 is configured for receiving a request for performing a financial transaction from an applicant and from one or more data sources 108. The request comprises application information of the applicant, financial information, health information, activity information, sourcing information of the applicant and the like. Further, the computing system 102 is configured for performing a data sufficiency check using one or more neural networks on the received request by validating the request of the applicant with trained neural network models. Furthermore, the computing system 102 is also configured for generating a decision for the received request using one or more neural network model if the data sufficiency check is successful. The decision comprises at least one of an acceptance decision of the request, customization decision and a rejection decision of the request. The neural network model comprises one or more neural layers comprising neural nodes representing an analysis of the application information of the applicant. Each of the neural nodes is assigned a weightage based on learnings derived from training data. Also, the computing system 102 is configured for validating the generated decision by reverse calculating, through the one or more neural layers of the neural network model, the importance weightage distribution across each of the neural node towards data features considered in the neural network. The computing system 102 further is configured to generate a case assessment report for the generated decision based on the validation. The case assessment report comprises explainable reasons for arriving at the decision by the neural network model, the importance weightage of each data feature considered, impact of each of the neural nodes on arriving at the decision and similar past transactions. Further, the computing system 102 is configured for performing the financial transaction with the applicant in response to the received request based on the generated case assessment report.

The external data sources 108 are external databases comprising additional application information of the applicant. In an exemplary embodiment, the applicant of the user device 106 applies an application for performing a financial transaction. The application may be for claiming an insurance, a loan application, a mortgage application or any other transaction that involves underwriting or adjudication or any other method of cognitive judgement to process the transaction. The details of the applicant applying for the application may be stored in the external data sources 108. The details of the applicant are then accessed by the computing system 102 via the network 104 for managing the financial transaction.

In one alternate embodiment, the user device 106 may itself act as a computing system 102 capable of managing the financial transaction. In such embodiment, the user device 106 itself comprises the plurality of subsystems. Further, in such embodiment, the user device 106 interacts with the one or more external data sources 108 to access the details of the applicant. Necessary additional information will be pulled from these external data sources 108 basis on the prediction of the neural network on data sufficiency check.

Those of ordinary skilled in the art will appreciate that the hardware depicted in FIG. 1 may vary for particular implementations. For example, other peripheral devices such as an optical disk drive and the like, Local Area Network (LAN), Wide Area Network (WAN), Wireless (e.g., Wi-Fi) adapter, graphics adapter, disk controller, input/output (I/O) adapter also may be used in addition or in place of the hardware depicted. The depicted example is provided for the purpose of explanation only and is not meant to imply architectural limitations with respect to the present disclosure.

Those skilled in the art will recognize that, for simplicity and clarity, the full structure and operation of all data processing systems suitable for use with the present disclosure is not being depicted or described herein. Instead, only so much of a computing system 102 as is unique to the present disclosure or necessary for an understanding of the present disclosure is depicted and described. The remainder of the construction and operation of the computing system 102 may conform to any of the various current implementation and practices known in the art.

FIG. 2 is a block diagram illustrating an exemplary computing system 102, such as those shown in FIG. 1, capable of for processing financial transaction, in accordance with an embodiment of the present disclosure. In FIG. 2, the computing system 102 comprises a processor 202, a memory 204, and a database 206. The processor 202, the memory 204 and the database 206 are communicatively coupled through a system bus 208 or any similar mechanism. The memory 204 comprises a plurality of subsystems 210 in the form of programmable instructions executable by the one or more processors 202. The plurality of subsystems 210 further includes a request handler module 212, a data sufficiency validation module 214, a decision generator module 216, a neural network neural network explainable module 218, a case assessment report generation module 220 and a financial transaction performer module 222.

The processor(s) 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The processor(s) 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the processor(s) 202, such as being a computer-readable storage medium. The processor(s) 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes a plurality of subsystems 210 stored in the form of machine-readable instructions on any of the above-mentioned storage media and may be in communication with and executed by the processor(s) 202.

The request handler module 212 is configured for receiving a request for performing a financial transaction from an applicant and from one or more external data sources 108. The request comprises application information, financial information, health information, activity information, sourcing information of the applicant of the applicant and the like. The application information of the applicant may include name, address, contact number, gender, occupation, income, medical, lifestyle, activity, wellness and any other information as required for the transaction. In an exemplary embodiment, the application information also includes applicant medical history, hospital visit records, wearable data, financial profile, credit profile, AML profile, government identification details, passport details, income details and occupation related details and the like. The financial transaction includes loan, mortgage, insurance claim, insurance policy issuance, financial activity and the like.

In receiving the request for performing the financial transaction from the applicant and from the one or more data sources 108, the request handler module 212 is configured for prompting one or more question relating to the application information of the applicant. For example, the one or more questions may start with basic data of the applicant such as name, age, city, occupation, industry, income, activity and the like. The request handler module 212 ensembles predicted outcome from multiple neural network models to aggregate scoring, for example, positive risk or negative risk. Based on the predicted score using these basic parameters, the request handler module 212 prompts specific additional questions collecting key data points that defines direction of the score. Based on answers to that questions, the request handler module 212 raises another question. The question can be asking for a data point such as ‘do you exercise regularly?’ or asking for a new data input such as ‘Can you share a photograph’ or asking for an additional document ‘Can you share your income proof?’ and the like. Such questions can also include accessing third party data sources upon getting consent from the applicant, such as ‘Can you share your EHR’. The applicant authenticates and shares consent to pull additional information of the applicant. The request handler module 212 predicts what is the most important question to ask from time to time from thousands of questions.

Further, the request handler module 212 is configured for receiving additional application information of the applicant as a response to the one or more questions. The additional application information of the applicant comprises of applicant's data, activity data, financial data, medical data, social data and the like as required for the transaction.

The data sufficiency validation module 214 is configured for performing a data sufficiency check using one or more neural network on the received request by validating the application information of the applicant with trained neural network models. Until all required data is received, the case is parked. Post collecting all required data from the applicant, the data sufficiency validation module 214 can acquire additional data from third party sources such as Bureau, central government data sources and the like. The data sufficiency validation module 214 prepares this additional data and the application information submitted by the applicant and sends this to the decision generator module 216. In case, all the required data from the applicant remains uncollected or is unavailable, then the data sufficiency check remains unsuccessful, and the request is rejected.

The decision generator module 216 is configured for generating a decision for the received request using a neural network model if the data sufficiency check is successful. The neural network model may be a deep learning model. The decision comprises at least one of an acceptance decision of the request, customization decision and a rejection decision of the request. The neural network model comprises one or more neural layers comprising neural nodes representing the analysis of the application information of the applicant as weights in these nodes. Each of the neural nodes are assigned a weightage based on the training data. Each of the neural nodes are optimized by backpropagating the inference error through gradient descent. The decision generator module 216 uses complex neural network architecture to decide on incoming request by learning from the historical data. Such learning is derived from training process. To make the decision generator module 216 dynamic and ready to learn any decision, the neural network has complex neural layers that makes it generalized enough to work on any similar tasks. Relevant neural layers gets activated basis on the tasks and the training data provided. In generating the decision for the received request using the neural network model if the data sufficiency check is successful, the decision generator module 216 is configured for generating one or more data features from the application information of the applicant. The one or more data features comprises all the data collected by the data sufficiency validation module 214 such as financial features of the applicant, health features of the applicant, contact features of the applicant and the like. Further, the decision generator module 216 is configured for applying the generated one or more data features onto the trained neural network model. The trained neural network model comprises the one or more neural layers comprising the neural nodes representing the analysis of the application information of the applicant and wherein each of the neural nodes are assigned the weights basis on the training on past transactions. For example, the data features are processed by passing the data features through the trained neural network model and creating the final decision based on the neural network model output. Furthermore, the decision generator module 216 is configured for determining whether the output of the trained neural network model meets acceptance criteria prestored in the database 206. The acceptance criteria may conform with guidelines defined by the applicant, such as the control functions. If the neural network model complies with such guidelines, then, additionally, the decision generator module 216 is configured for generating the decision for the received request based on the output of the neural network model and based on the determination. After processing the request for performing the financial transaction, each completed financial transaction is stored as a past financial transaction case.

In an embodiment, the neural network explainable module 218 is configured for generating explainable and traceable outcomes to the applicant on system performance. Deep Learning systems using neural networks have been considered as largely black box models. While there are certain methods, these methods tend to work for only certain types of neural network architectures. Integrated Gradients and Shapley values are other exemplary methods available for calculating feature importance from Deep Learning Model. Both of these methods give approximate neural node importance weightage. Integrated Gradients depends on a baseline sample which needs to be constructed for the dataset and altered as the dataset shifts. This is extremely difficult for a high dimensional dataset. Shapely Values are calculated on a sample set selected from the complete data set. This makes those values highly dependent on the selection of data.

The neural network explainable module 218 is designed to address this problem. For example, when once a final decision is completed, an overall score is assigned to the final decision by the model. The overall score can have any value based on the scope of the intended solution. This importance weightage is then decoded by propagating the overall score backwards into the neural network. For any internal neural node within the neural network, their importance weightage is proportionately distributed among their child nodes and internal biases. The propagation stops when all internal nodes have been assigned importance weightage. The importance weightage assigned are additive in nature. As long as two internal nodes does not exist in the same path inside the network, their importance can be added for compound analysis. This has been explained above with equations.

In an embodiment, with each internal node being assigned a fraction of the overall score, the neural network explainable module 218 quantifies dependence of final decision on each internal node. The neural network explainable module 218 with the decision generator module 216 evaluates the dependence within each of the internal node as the importance assignment happens on per unit basis.

The neural network explainable module 218 is configured for validating the generated decision by reverse calculating, through the one or more neural layers of the neural network model, an importance weightage distribution across each of the neural nodes towards data features considered in the neural network. In validating the generated decision by reverse calculating, through the one or more neural layers of the neural network model, the importance weightage distribution across each of the neural nodes, the neural network explainable module 218 is configured for assigning an overall score to the generated decision. Further, the neural network explainable module 218 is configured for assigning importance weightage to each of the neural node within the neural network model by propagating in a backward direction starting from final neural layer to first neural layer of the neural network model. Each neural network model comprises first layer to final layer with multiple layers in between. Each of these layers includes many neural nodes. The importance weightage is proportionately distributed among one or more child nodes of the neural node and internal biases. Furthermore, the neural network explainable module 218 is configured for determining whether the assignment of the importance weightage is completed to all of the neural nodes within the neural network model. Additionally, the neural network explainable module 218 is configured for determining a neural node importance weightage for each of the assigned importance weightage of the neural node. The neural node importance weightage indicates impact of each of the neural nodes on arriving at the decision. Also, the neural network explainable module 218 is configured for computing aggregate importance weightage by summing each of the assigned importance weightage assigned initially to each of the neural node within the neural layer until the data features considered in the neural network at the layer level or overall data feature level. Further, the neural network explainable module 218 is configured for correlating the aggregated importance weightage with the request indicating usage of the application information of the applicant, the financial information, the health information, the activity information, and the sourcing information on arriving at the final decision.

In an embodiment, this step of validating the generated decision has following advantages. Every neural network model is analysed based on certain performance metrics which are calculated over a compiled validation dataset. This does not represent live deployment scenario. During deployment, validation of the generated decision is extremely important for complete autonomous systems. The neural layer wise importance weightage is used for accomplishing this. The importance weightage for each neural layer is mapped in vector space of the same dimension as the neural layer's decision, yet it is linearly related to the neural network model's final decision. Since the information changes as it passes through the neural network, the importance weightage from lower neural layers, even input neural layers, are used to obtain different decisions. These decisions are then used to validate the final decision of the neural network model. The neural layers are generally multi-dimensional for which either proximity-based methods or white-box regression algorithms may be used to derive decisions (also referred herein as outcomes).

In operation, each neural network consists of multiple neural layers. Each neural layer has a variation of the following basic operation:

y=Φ(Wx+b) equation (1)

where,

Φ=activation function;

W=weight matrix of the neural layer;

b=bias;

x=input; and

y=output;

This can be further organized as:

y=Φ(Xₚ+Xₙ+b) equation (2)

where,

Xₚ=ΣWᵢxᵢ∀Wᵢxᵢ>0 equation (3)

Xₙ=ΣWᵢxᵢ∀Wᵢxᵢ<0 equation (4)

Activation functions are categorized into monotonic and non-monotonic functions. These activation functions are mathematical functions. These are common component of all neural networks for non-monotonic functions, overall score is propagated as is. In case of monotonic functions, the overall score is switched off for positive or negative components based on saturation.

The algorithm for assigning importance weightage to each of the neural nodes within the neural network model by propagating in a backward direction starting from final neural layer to first neural layer of the neural network model comprises two modes of operations, default mode and contrastive mode.

In the default mode of operation, there is a single importance weightage associated with each subcomponents of a neural network node, refereed as ‘unit’. This importance weightage is propagated by proportionately distributing the single importance weightage between positive and negative components. For example, if the importance weightage associated with y is r_{y} and with x is rₓ, then for jth unit in y:

$${T}^{j} = {X}_{p}^{j} + \vert {X}_{n}^{j} \vert + \vert {b}^{j} \vert \qquad equation ( 5 )$$

$${R}_{p}^{j} = ( \frac{{X}_{p}^{j}}{{T}^{j}} ) {r}_{y}^{j} \qquad equation ( 6 )$$

$${R}_{n}^{j} = ( \frac{{X}_{n}^{j}}{{T}^{j}} ) {r}_{y}^{j} \qquad equation ( 7 )$$

$${R}_{b}^{j} = ( \frac{{b}^{j}}{{T}^{j}} ) {r}_{y}^{j} \qquad equation ( 8 )$$

Where Rₚ^{j} and Rₙ^{j} are distributed among x in the following manner:

$$\begin{matrix}{r}_{x i}^{j} = ( {W}_{i}^{j} {x}_{i}^{j} / {X}_{p}^{j} ) {R}_{p}^{j} & ∀ {W}_{i}^{j} {x}_{i}^{j} > 0 \\ 0 & ∀ {W}_{i}^{j} {x}_{i}^{j} > 0 if Φ is saturated on negative end \\ & ( - {W}_{i}^{j} {x}_{i}^{j} / {X}_{n}^{j} ) {R}_{n}^{j} ∀ {W}_{i}^{j} {x}_{i}^{j} < 0 \\ 0 & ∀ ( {W}_{i}^{j} {x}_{i}^{j} < 0 if Φ is saturated on positive end \\ 0 & ∀ {W}_{i}^{j} {x}_{i}^{j} = 0\end{matrix} \qquad equation ( 9 )$$

$${r}_{x i} = {\sum }_{1}^{j} {r}_{x i}^{j} \qquad equation ( 10 )$$

Total importance weightage at neural layer x,

rₓ=Σ₁ⁱrₓᵢ equation (11)

In contrastive mode of operation, there is dual importance weightage associated with each unit. This dual importance weightage is propagated by proportionately distributing the dual importance weightage between positive and negative components. For example, if the dual importance weightage associated with y are r_{yp}, r_{yn} and with x are rₓₚ, rₓₙ, then for jth unit in y:

T^{j}=Xₚ^{J}+Xₙ^{j}+b^{j} equation (12)

if T^{j}>0, then

if r_{yp}ⁱ>r_{yn}:

Rₚ^{j}=r_{yp}^{j}

Rₙ^{j}=r_{yn}^{j}

importance_polarity=1

else

Rₚⁱ=r_{yn}^{j}

Rₙ^{j}=r_{yp}^{j}

importance_polarity=−1

else:

if r_{yp}^{j}>r_{yn}:

Rₚ^{j}=r_{yn}^{j}

Rₙ^{j}=r_{yp}^{j}

importance_polarity=−1

else:

Rₚ^{j}=r_{yp}^{j}

Rₙ^{j}=r_{yn}^{j}

importance_polarity=1

Also, Rₚⁱ and Rₙ^{j} a are distributed among x in the following manner:

$$if importance\_polarity > 0 , then {r}_{x p , {i}^{j}} = ( \frac{{W}_{i}^{j} {x}_{i}^{j}}{{X}_{p}^{j}} ) {R}_{p}^{j} ∀ {W}_{i}^{j} {x}_{i}^{j} > 0 \qquad equation ( 13 )$$

$${r}_{x n , {i}^{j}} = ( \frac{- {W}_{i}^{j} {x}_{i}^{j}}{{X}_{n}^{j}} ) {R}_{n}^{j} ∀ {W}_{i}^{j} {x}_{i}^{j} < 0 \qquad equation ( 14 )$$

$$else$$

$${r}_{x p , {i}^{j}} = ( \frac{- {W}_{i}^{j} {x}_{i}^{j}}{{X}_{n}^{j}} ) {R}_{n}^{j} ∀ {W}_{i}^{j} {x}_{i}^{j} < 0 \qquad equation ( 15 )$$

$${r}_{x n , {i}^{j}} = ( \frac{{W}_{i}^{j} {x}_{i}^{j}}{{X}_{p}^{j}} ) {R}_{p}^{j} ∀ {W}_{i}^{j} {x}_{i}^{j} > 0 \qquad equation ( 16 )$$

$${r}_{x p , i} = {\sum }_{1}^{j} {r}_{x p , {i}^{j}} \qquad equation ( 17 )$$

$${r}_{x n , i} = {\sum }_{1}^{j} {r}_{x n , {i}^{j}} \qquad equation ( 18 )$$

Total importance weightage at neural layer x:

Positive importance weightage rₓₚ=Σ₁ⁱr_{xp,i} equation (19)

Negative importance weightage rₓₙ=Σ₁ⁱr_{xn,i} equation (20)

The aforementioned modes are the basic operation taking place at every source neural layer for importance weightage propagation to the destination neural layer. The number and coefficients of these operations change based on type and mathematical functions of the source neural layer.

The propagation from one layer to its immediate connected layer is backwards which requires all the operations within a layer to be performed in the reverse order.

For a convolution layer, the input I is in the format h×w×d where h is height, w is width and d is depth. The Kernels or filters K of the layer are in the format m×n×d×c where m is height, n is width, d is the depth on input and c number of kernels/filters. m<=h and n<=w

A single operation in the layer can be written as:

Y=Σ₁^{m}Σ₁ⁿΣ₁^{d}(kXⁱ)+b equation (21)

where k is a filter, Xⁱ is an input patch with dimensions m×n×d and b is the bias. Y is a single value with a single importance weightage value associated with it. This importance value is propagated back to the input patch Xⁱ via the aforementioned methods to create an importance weightage patch Rⁱ. This Rⁱ is scaled to the dimension of the input maintaining the original index for accumulation.

The propagation is conducted for every value in the output of the layer. The output dimensions are p×q×c where:

p=(h−m+2P^{h})/s^{h} equation (22)

where h, m are heights of image and kernel respectively, p^{h} is the padding for the height and s^{h} is the stride along the first dimension.

q=(w−n+2P^{w})/s^{w} equation (23)

where w, n are widths of image and kernel respectively, P^{w} is the padding for the height and s^{w} is the stride along the second dimension.

c is the number of kernels or filters.

The number of m×n×d dimension X patches are pqc. The number of importance weightage patches R is also pqc. The importance weightage for the input layer to the Convolution layer can now be calculated as:

R=Σ₁^{pqc}Rⁱ equation (24)

All other complex layers follow a similar procedure for propagation of importance weightage for layer-to-layer transmission. All the operations are reverse calculated, and the same base algorithm is applied at each operation to create intermediate importance weightage matrices until all operations for the layer in focus are completed.

The procedure for importance weightage calculation is as follows. At first, a graph with output neural nodes at root and input neural nodes in the leaves is constructed from neural network model weights and architecture. Second, the propagation starts at root and proceeds in breadth-first manner to avoid re-processing of any neural node. Third, the propagation completes when all the leaves (input neural nodes) have been assigned the importance. Any loss of importance weightage during propagation is due to network bias. The importance weightage of a single transactional record represents local importance. Lastly, for global or overall score on data, the importance weightage of each feature is aggregated after normalization on the single transactional record. Using the local and global importance weightage of features and ranking them accordingly, it can be determined whether the neural network model is considering the data features in the same manner as in the business process it is emulating. This also helps in evaluating the solution's alignment with various business and regulatory requirements. Further, based on the global importance weightage of sensitive data features such as gender, age and the like, and their alignment with the data, it can be inferred whether the neural network model or data have undue bias towards any feature value.

In an embodiment, the neural network explainable module 218 is further configured for: determine performance of the trained neural network models based on the one or more financial transactions during a training stage; and perform one or more tasks associated with the trained neural network model based on the determined performance of the trained neural network models. The one or more tasks may include, for example, feature engineering, network pruning, hyperparameter optimization, data balancing and the like.

The case assessment report generation module 220 is configured for generating a case assessment report for the generated decision based on the validation. The case assessment report comprises explainable reasons for arriving at the decision by the neural network model, the importance weightage of each data feature considered, and impact of each the neural nodes on arriving at the decision as generated by the neural network explainable module 218 and similar past transactions as compared to current transactions. In generating the case assessment report for the generated decision based on the validation, the case assessment report generation module 220 is configured for mapping the one or more data features associated with the application information, financial information, health information, activity information, sourcing information of the applicant of the applicant with corresponding set of explainable reasons for arriving at a decision pre-stored in a database 206. Further, the case assessment report generation module 220 is configured for prioritizing each of the set of explainable reasons based on descending order of the neural node importance weightage for each or combination of the data features. Also, the case assessment report generation module 220 is configured for selecting at least one among the set of explainable reasons having descending order of priority based on the assigned importance weightage to each of the neural node along with aggregate of the assigned importance weightage. These reasons can be categorized as product related, financial related, profile related, medical related and the likes. The case assessment report also contains similar cases from the past data. This is generated by calculating the similarity score using the importance weightage of each neural node generated by neural network explainable module 218 on current transaction and compared to each transaction in the past data. Furthermore, the case assessment report generation module 220 is configured for generating the case assessment report for the generated decision comprising the selected at least one explainable reason, the importance weightage of each data feature considered, impact of each the neural nodes on arriving at the decision as generated by the neural network explainable module 218 and similar past transactions.

In an embodiment, the case assessment report generation module 220 is configured for retrieving the similar past transactions from training datasets using the importance weightage; and generating the case assessment report for the generated decision comprising the retrieved similar past transactions.

In an embodiment, the case assessment report generation module 220 is further configured for: generating alert messages indicating at least one of: possible model drifts and data drift based on the calculated importance weightage; and transmitting the generated alert messages to the one or more end users.

In an embodiment, feature wise templated reasons are listed for the case assessment report generation module 220 to pick. Based on the importance weightage of each feature or combination of these features plus aggregate importance, the case assessment report generation module 220 picks the right templated reason and presents the right templated reason to the applicant. Such right templated reasons are aligned with the importance weightage of each feature. Hence, the reasons are listed in decreasing order of priority. Top reason has more importance weightage on the decision, followed by second and then third and the like.

In addition to textual reasons, the decision generator module 216 matches the similar features with the past cases to extract similar cases from the past transaction cases. Similar cases are fetched based on proximity of past cases to the current case. The proximity is calculated using the neural network explainable module 218 output of any set of nodes from the neural network, preferably the input nodes. For proximity either the distance-based similarity metrics or white-box regression algorithms can be used. The case assessment report generation module 220 aggregates all these information and creates a case assessment report summing the decision generator module 216 outcome.

The financial transaction performer module 222 is configured for performing the financial transaction with the applicant in response to the received request based on the generated case assessment report.

Further, the plurality of subsystems 210 comprises a guideline generation and simulation module configured for defining one or more control functions corresponding to each or combination of the data features used in the neural network model or available in application data. The one or more control functions may be straight forward guidelines or composite guidelines basis on variables collected or processed by the decision generator module 216. For example, the one or more control functions may be rules such as ‘do not process transactions worth more than ‘X’ value’ or ‘if this <Condition>, then <condition>, and the like. Further, the guideline generation and simulation module is configured for simulating the defined one or more control functions automatically in a simulation environment. The simulation environment emulates the neural network model, and the simulation environment is created based on applicant preferences such as picking up a ‘transaction within a geography’, ‘transactions of a product’ and the like to ensure these guidelines as generated or created as per applicant requirements. Additionally, neural network-based model is used to generate these guidelines to mitigate the errors, bias or other factors that can impact negatively on the model performance. If required, such guidelines generated by the model is presented to the applicant to validate and approve. Furthermore, the guideline generation and simulation module configured for updating these guidelines with the defined one or more control functions based on results of testing. The results of simulation may be success of failure, where success indicates successful validation of the one or more control functions and meeting the test criteria defined by the applicant. Failure indicates failure of validation of the one or more control functions and not meeting the test criteria defined by the applicant. Also, the guideline generation and simulation module configured for storing the updated guidelines along with neural network model created by decision generator module 216 as a learning in a database 206.

For manual definition of the guidelines, the guideline generation and simulation module is designed to give additional controls to the applicants through a graphical user interface (GUI). The GUI allows applicants to identify bias, check the errors, failure state of the system and also to define functional guidelines accordingly. These guidelines act as a functioning framework for the decision generator module 216 to work. Such guidelines may be as simple as value based (for example, do not process transactions worth more than ‘X’ value) or complex guidelines identified based on experience of the applicants or observations from the data. By combining ‘Model prediction and functional guidelines’ creates a new version of the decision generator model. Such guidelines can also represent the regulatory or compliance requirements of the product. To augment the efforts of the applicant in creating these guidelines, one or more neural network is used to analyse the features, importance weightage generated by neural network explainable module 218 to suggest additional guidelines or control functions. The applicant can pick these guidelines as-is or customize them further before creating them as a new guideline.

To allow the applicant to test the impact of the new version of the model, the guideline generation and simulation module creates a simulated test environment. The simulated environment (also referred herein as ‘simulation environment’) is created as per requirement of the applicant such as picking up a ‘transaction within a geography’, ‘transactions of a product’ and the like. The guideline generation and simulation module may build more specifications of these simulated test environments. Post completion of the simulated test setup, the guideline generation and simulation module tests the new version within the test environment and validate the new model. Post completion of testing, the guideline generation and simulation module pushes this new model version in live with a single click. Further, the administrator users may view all the activities of workbench in the GUI along with user level activity for a clear audit trail on the computing system 102.

Users can use the GUI to track the bias or model drift in production. The computing system 102 uses the local and global importance weightage of features generated by neural network explainable module and ranking them on all transactions, the system can highlight if there is any bias in the data. Further, based on the global importance weightage of sensitive data features such as gender, age and the like, and their alignment with the data, it can be inferred whether the neural network model or data have undue bias towards any feature value. The applicant can monitor such bias in the data. Furthermore, during live transactions the computing system 102 plots the model drift by calculating the deviation of the aggregate of feature wise importance weightage for temporally separated cases. Such model drift can also be calculated for preferred features.

For more advance user, the feature wise importance weightage and neural node wise importance weightage generated by neural network explainable module can be used for model pruning. They can decode the neural network easily and understand the specified areas in the network where they can modify or edit or delete to improve the model performance.

The financial transaction performer module 222 is configured for performing the financial transaction with the applicant in response to the received request based on the generated case assessment report as explained.

Further, the decision generator module 216 is configured for collecting feedback for the generated decision from cases where decisioning is unsuccessful, cases where system errors are made, and the financial transaction requests processed successfully. Also, the decision generator module 216 is configured for updating the collected feedback as learning in the database 206. Specifically, the decision generator module 216 collects feedback from three main sources, transaction cases where the decisioning was not successful, transaction cases where the decision generator module 216 made errors and subsequent performance of the transactions processed successfully by the decision generator module 216.

The decision generator module 216 is built in with ‘reverse feed’ capability. True values of the transactions are shared in real time through reverse feed application programming interfaces (APIs) or batch wise feedback data sharing. The decision generator module 216 aggregates such feedback.

In an embodiment, the decision generator module 216 is further configured for automatically triggering a model retraining process for the neural network model at predefined time or data intervals on basis of criteria defined by the user on model drift. The decision generator module 216 has automated model tuning called ‘simulation AI’. The model retraining process generates revised hyper features like for the neural network model. Further, the decision generator module 216 is further configured for validating the revised hyper features for the neural network model by simulating the revised hyper features in a simulating environment.

The model retraining process updates the models on key hyper/network parameters such as optimal batch size for improved learning, learning rate, epochs and target metrics for the neural network model. The computing system 102 runs multiple simulations to iterate on multiple possible improvements on hyper parameter or network parameters to find the best suitable model.

Further, the decision generator module 216 is further configured for validating the model for the retrained neural network model by testing it in a simulated testing environment. Also, the decision generator module 216 is further configured for updating the neural network model with the revised hyper and network parameters if the simulation is successful. The simulation environment may be a virtual environment of the neural network model and is developed using one of the known mechanism in the art. In an embodiment, retraining and learning from feedback is as important as learning from past data. The applicant may define frequency of running the neural network model again on this past data. The decision generator module 216 can automatically trigger the retraining process and initiate training server to complete training. While retraining the decision generator module 216, same hyper parameters may not be fit for new feedback data. This simulation AI tunes the hyper parameters of the decision generator module 216's model as required for the new data and updates the neural network model. Once the neural network model is updated, the decision generator module 216 can replace the old neural network model with a newly retrained neural network model.

User of the system can also define the specifications of test environment and success criteria. Before pushing the new neural network model into production, the guideline generation and simulation module (as described later) runs the new neural network model in a simulated user acceptance testing (UAT) environment as defined by the applicant to ensure that the new neural network model is meeting the minimum performance metrics as required by the applicant. This minimum performance metrics include bias in the model, accuracy, error rate, false positives or any other model performance benchmarking method is the acceptance criteria. Upon satisfactory validation, the decision generator module 216 replaces the existing neural network model with a new neural network model.

The database 206 stores the information relating to the applicant and other related information. The database 206 is, for example, a structured query language (SQL) data store. The database 206 is configured as cloud-based database implemented in the computing environment 100, where software application are delivered as a service over a cloud platform. The database 206, according to another embodiment of the present disclosure, is a location on a file system directly accessible by the plurality of subsystems 210. The database 206 is configured to store the one or more features, neural node importance weightage, case assessment report, transaction cases, past learnings, weights and the like.

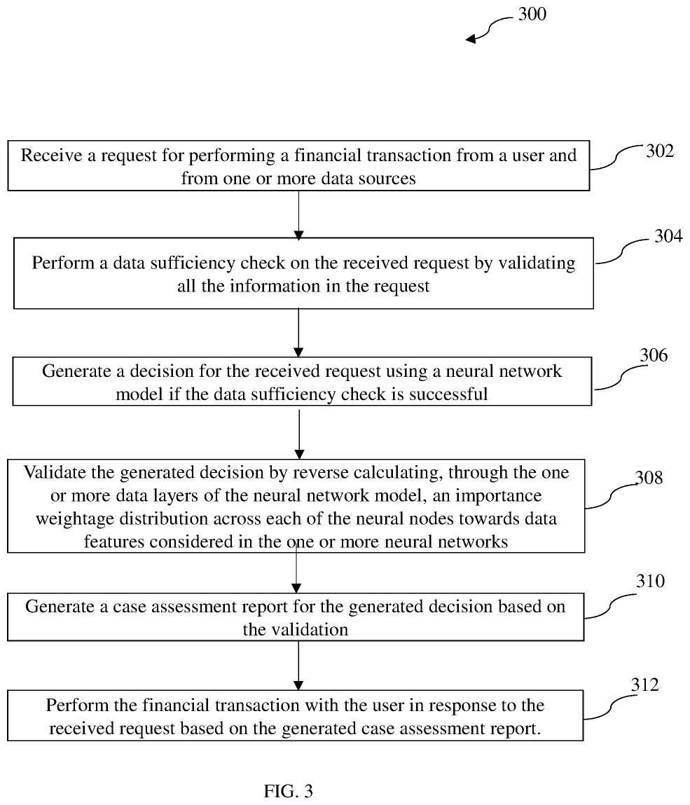

FIG. 3 is a process flow diagram illustrating an exemplary method 300 for managing financial transactions, in accordance with an embodiment of the present disclosure. At step 302, a request for performing a financial transaction is received from an applicant and from one or more data sources 108. The request comprises of application information of the applicant, financial information, health information, activity information, sourcing information of the applicant and the like. At step 304, a data sufficiency check is performed using one or more neural networks on the received request by validating the application information of the applicant with trained neural network models. At step 306, a decision for the received request is generated using a neural network model if the data sufficiency check is successful. The decision comprises at least one of an acceptance decision of the request, customization decision and a rejection decision of the request. The neural network models used comprises one or more neural layers comprising neural nodes connected to one another as layers with weightage calculated at each node representing an analysis of the application information of the applicant. Each of the neural nodes are assigned an importance weightage. At step 308, the generated decision is validated by reverse calculating, through the one or more neural layers of the neural network model, an importance weightage distribution across each of the neural nodes towards the data features considered in the neural network. At step 310, a case assessment report for the generated decision is generated based on the validation. The case assessment report comprises explainable reasons for arriving at the decision by the neural network model, impact of each the neural nodes on arriving at the decision and similar past transactions. At step 312, the financial transaction with the applicant is performed in response to the received request based on the generated case assessment report.

In receiving the request for performing the financial transaction from the applicant and from the one or more data sources, the explainable artificial intelligence based decisioning method includes prompting one or more questions relating to the application information of the applicant; and receiving additional application information of the applicant as a response to the one or more questions. The application information of the applicant comprises personal data, financial data, medical data, lifestyle data, activity data and the like.

In generating the decision for the received request using the neural network model if the data sufficiency check is successful, the explainable artificial intelligence based decisioning method includes generating one or more data features for the application information of the applicant. Also, the explainable artificial intelligence based decisioning method includes applying the generated one or more features onto a trained neural network model. The trained neural network model comprises one or more neural layers comprising neural nodes representing an analysis of the application information of the applicant. The each of the neural nodes in the neural network are assigned weightage values. Further, the explainable artificial intelligence based decisioning method includes determining whether output of the trained neural network model meets acceptance criteria prestored in the database 206. Also, the explainable artificial intelligence based decisioning method includes generating the decision for the received request based on the output of the trained neural network model and based on the determination.

In validating the generated decision the generated decision by reverse calculating, through the one or more neural layers of the neural network model, the neural network explainable module is configured for assigning an overall score to the generated decision and assigning importance weightage to each of the neural node within the neural network model by propagating in a backward direction starting from final neural layer to first neural layer of the neural network model; where the importance weightage is proportionately distributed among one or more child nodes of the neural node and internal biases. Further, the explainable artificial intelligence based decisioning method includes determining whether the assignment of the importance weightage is completed to all of the neural nodes within the neural network model. Also, the explainable artificial intelligence based decisioning method includes determining a neural node importance weightage for each of the assigned importance weightage of the neural node, where the neural node importance weightage indicates impact of each of the neural nodes on arriving at the decision. Furthermore, the explainable artificial intelligence based decisioning method includes computing aggregate importance weightage by summing each of the assigned importance weightage initially to each of the neural node within the neural layer until the data features considered in the neural network. Further, the explainable artificial intelligence based decisioning method includes correlating the aggregated importance weightage with the request indicating usage of the application information of the applicant, the financial information, the health information, the activity information, and the sourcing information on arriving at the final decision

In generating the case assessment report for the generated decision based on the validation, the explainable artificial intelligence based decisioning method includes mapping one or more data features associated with the application information of the applicant with corresponding set of explainable reasons for arriving at a decision pre-stored in a database 206. Further, the explainable artificial intelligence based decisioning method includes prioritizing each of the set of explainable reasons based on the descending order of the neural node importance weightage for each of the data feature. Furthermore, the explainable artificial intelligence based decisioning method includes selecting at least one among the set of explainable reasons having the descending order of priority based on the assigned importance weightage to each of the neural nodes along with aggregate of the assigned importance weightage. The explainable artificial intelligence based decisioning method also identifies similar transactions from the past by calculating the similarity score between the current transaction and the past transaction using a neural network or any white box regression models. Also, the explainable artificial intelligence based decisioning method includes generating the case assessment report for the generated decision comprising the selected at least one explainable reason, importance weightage of each of the neural nodes on arriving at the decision and similar past transactions.

The explainable artificial intelligence based decisioning method further includes defining one or more control functions as guidelines corresponding to each of the neural nodes within the neural network model. The explainable artificial intelligence based decisioning method further includes simulating the defined one or more control functions in a simulation environment using a neural network to arrive at new guidelines. The simulation environment emulates the neural network model. Furthermore, the explainable artificial intelligence based decisioning method includes updating the neural network model with these defined one or more control functions based on results of testing in test or simulation environment. Also, the explainable artificial intelligence based decisioning method includes storing the updated neural network model as a learning in a database 206.

The explainable artificial intelligence based decisioning method further includes automatically triggering a model retraining process for the neural network model at predefined time or data intervals on basis on the criteria defined by the user on model drift, where the model retraining process generates revised hyper parameters or network parameters for the neural network model; validating the neural network model by testing it in a test environment; and updating the neural network model with the revised hyper or network parameters if the simulation is successful.

The explainable artificial intelligence based decisioning method further includes collecting feedback for the generated decision from cases where decisioning is unsuccessful, cases where system errors are made, and the financial transaction requests processed successfully; and updating the collected feedback as learning in the database 206.

In generating the case assessment report for the generated decision based on the validation, the explainable artificial intelligence based decisioning method includes retrieving the similar past transactions from training datasets using the importance weightage; and generating the case assessment report for the generated decision comprising the retrieved similar past transactions.

The explainable artificial intelligence based decisioning method further includes an explainable framework that can be used by advance users to determine performance of the trained neural network models based on the one or more financial transactions during a training stage; and perform one or more tasks associated with the trained neural network model based on the determined performance. The one or more tasks include feature engineering, network pruning, hyperparameter optimization, data balancing and the like.

The explainable artificial intelligence based decisioning method further includes generating alert messages indicating at least one of: possible model drifts and data drift based on the calculated importance weightage; and transmitting the generated alert messages to the one or more end users.

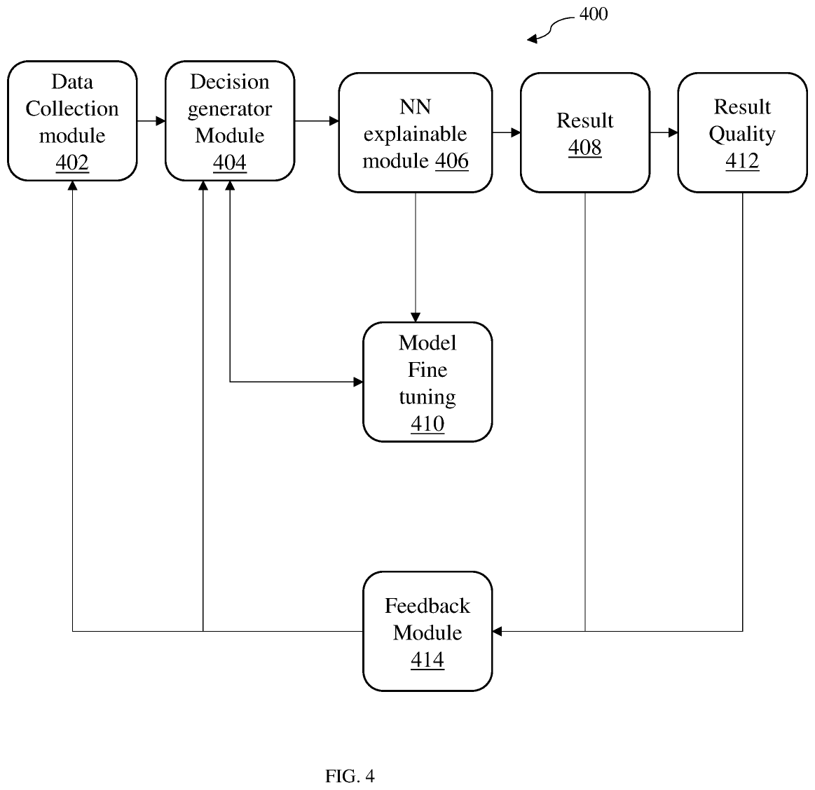

FIG. 4 is a block diagram illustrating an exemplary process 400 for processing financial transaction, in accordance with an embodiment of the present disclosure. The data collection module 402 includes a request handler module 212 and a data sufficiency validation module 214. The data collection module 402 collects application information from the applicant, personal, professional, financial, medical and any other application data of the applicant and the like. and validate the application information and using one or more neural networks. Further, the decision generator module 404 generates a decision for the received request using a neural network model if the data sufficiency check is successful. The decision comprises at least one of an acceptance decision of the request, customization decision and a rejection decision of the request. The neural network models comprises one or more neural layers comprising neural nodes representing an analysis of the application information of the applicant and wherein each of the neural nodes in the network are optimized based on historical data to predict the final decision. Further, the neural network explainable module 406 validates the generated decision by reverse calculating, through the one or more neural layers of the neural network model, an importance weightage distribution across each of these neural nodes in the neural network. The generated decision is the result 408. The result quality 412 is used by the feedback module 414 to feed to the decision generator module 404 for collecting feedback for the generated decision from cases where decisioning is unsuccessful, cases where system errors are made, and the financial transaction requests processed successfully and updating the collected feedback as learning in the database. The model fine tuning 410 along with the decision generator module 404 modifies the neural networks model based on the feedback, one or more control functions, retraining process and updates the neural network model.

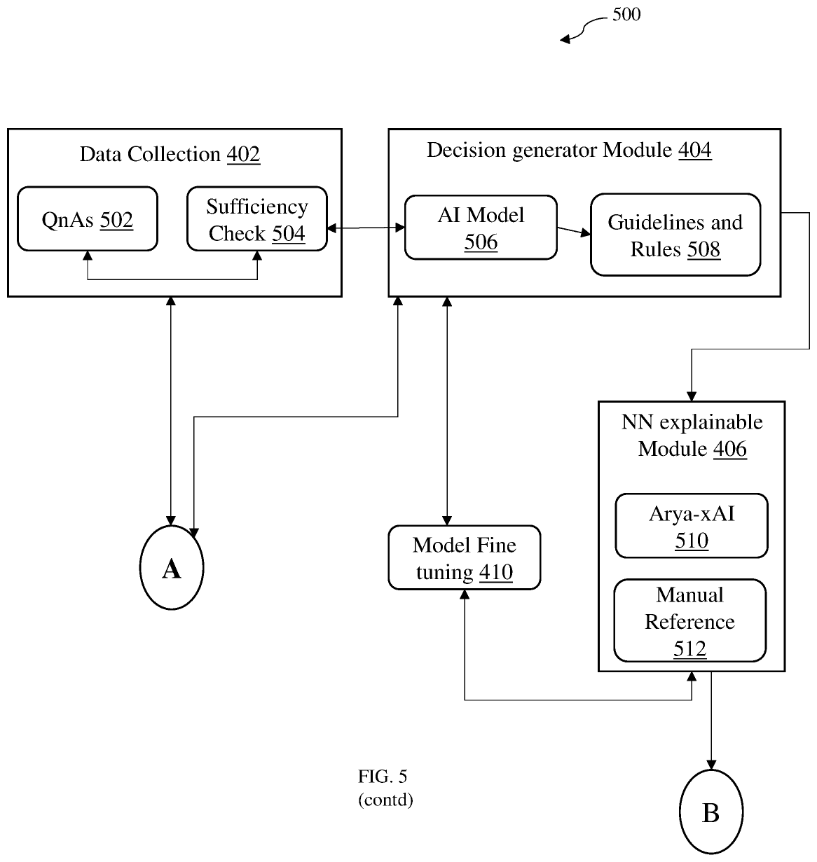

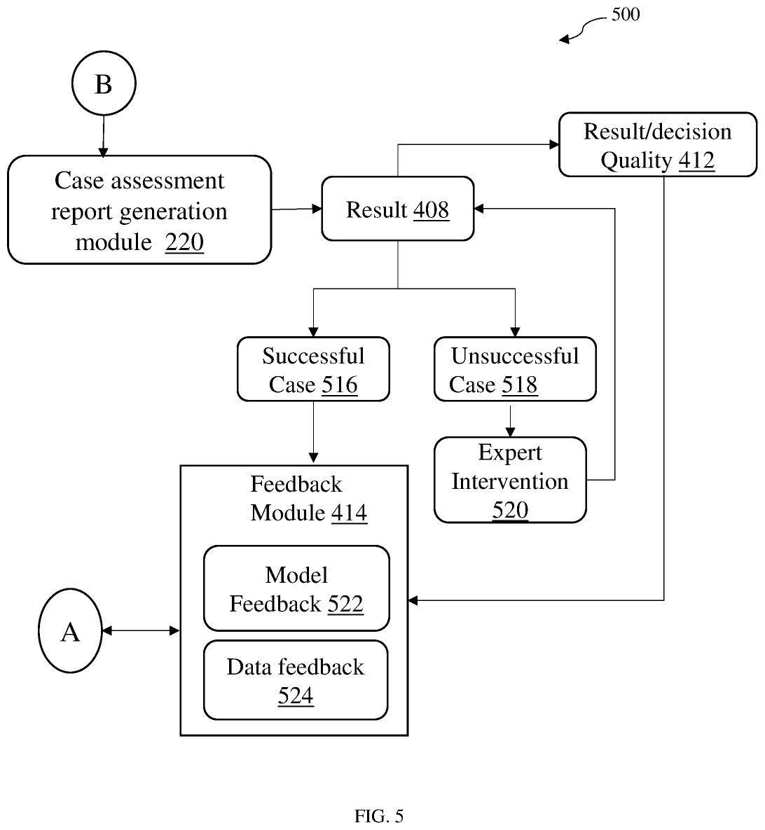

FIG. 5 is a block diagram illustrating a detailed component overview of the exemplary computing system 500, such as those shown in FIG. 2, capable of processing financial transaction, in accordance with an embodiment of the present disclosure. The data collection subsystem 402 comprises Questions and Answers (QnAs) 502, and sufficiency check module 504. The decision generator module 404 comprises an AI model built using neural networks 506 and a guidelines and rules module 508. The arya-xai module 406 comprises neural network explainable module 510 and user GUI 512. The output of the arya-xai module 406 is fed to a case assessment report generation module 220 and the model fine tuning module 410. Further, the output of the case assessment report generation module 220 is the result 408, which is a final outcome or a decision. The result 408 may be a successful case 516 or an unsuccessful case 518. In case of the unsuccessful case 518, an expert intervention 520 is sought and the result 408 is further classified as successful case 516 or unsuccessful case 518. This classification is fed into the feedback module 414 comprising the model feedback 522 and data feedback 524. The feedback module 414 also analyses result quality 412 for generating a feedback. The output of the feedback module 414 is fed to the data collection subsystem 402 and the decision generator module 404.

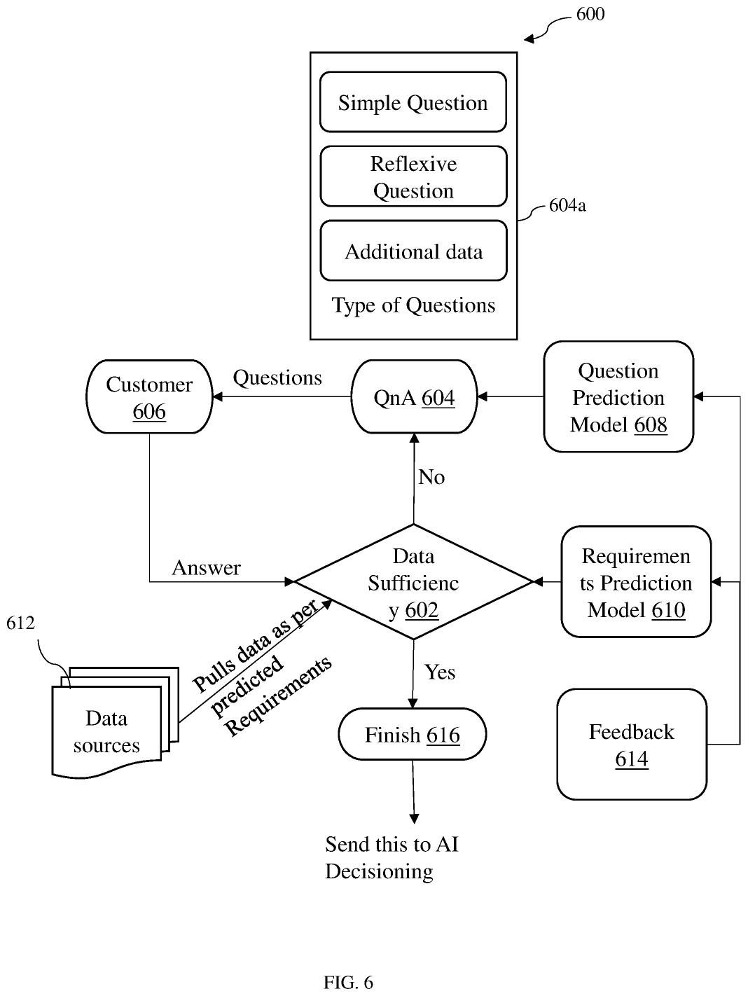

FIG. 6 is a block diagram illustrating various components of an exemplary data collection module 402, such as those shown in FIG. 5, in accordance with an embodiment of the present disclosure. During a data sufficiency check 602, if the data collection module 402 determines that the data is insufficient, then a set of Questions 604 are generated and provided to the applicant 606. The responses or answers from the customer 606 are collected and the data sufficiency check 602 is repeated until the data collected is completely sufficient. For generating the questions 604, questions prediction model 608 is used. The questions and answers 604 may be in the form of different types of questions 604a, such as simple questions 604a, reflexive questions, additional data and the like. For determining the data sufficiency, requirement prediction model 610 and data 612 retrieved as per predicted requirement may be used. For the questions prediction model 608 and the requirement prediction model 610, the output from the feedback module 614 is used. After successful check on data sufficiency, the loop is completed 616 and the data is sent to decision generator module 404.

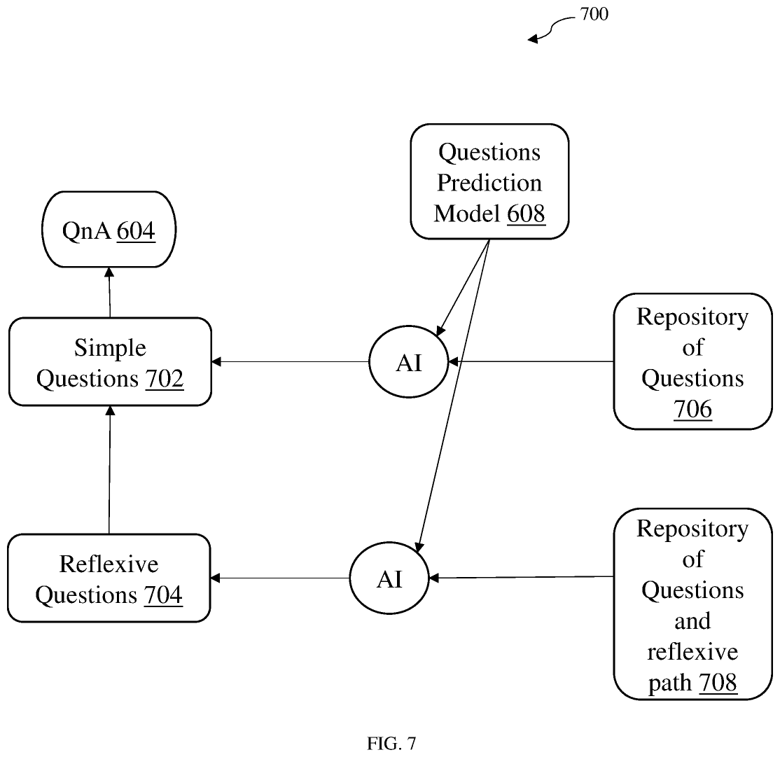

FIG. 7 is a block diagram illustrating an exemplary questions model 700, such as those shown in FIG. 6, in accordance with an embodiment of the present disclosure. Questions to be asked is generated by another neural network or machine learning model. Basis on the past learning, and data provided, the neural network predicts a score as output model and is used to define what question to be asked. Questions can be divided into simple questions where there is no relation, reflexive questions where questions are linked to one another. The system has access to repository of questions from which the system picks the questions. When the applicant start answering to these questions or providing request data, the neural network calculates a score. Depending the on the answers, the score can move positively or negatively. If the score is moving towards negative direction, more complex flow of reflexive questions will be raised. The neural networks stops asking additional questions if the data sufficiency model concludes as ‘complete’ or the score reaches to a predefined levels of risk profile.

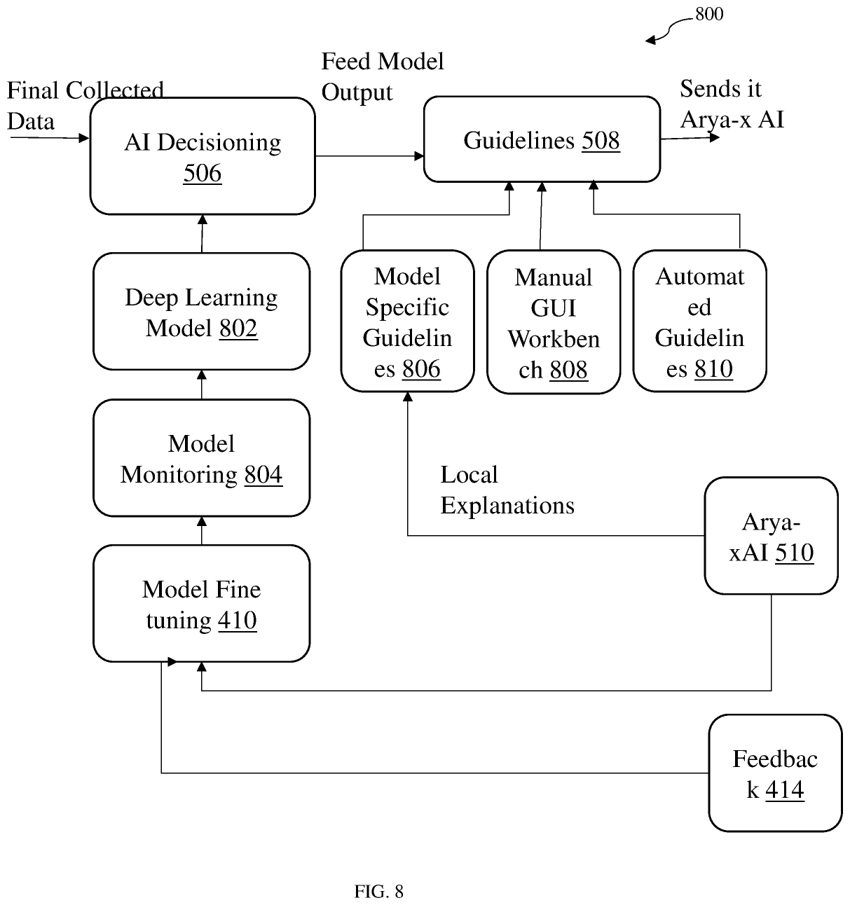

FIG. 8 is a block diagram illustrating various components of an exemplary decision generator module 404, such as those shown in FIG. 5, in accordance with an embodiment of the present disclosure. The final data collected is fed into the AI decisioning model 506 from the data collection module 402. The AI decisioning model 506 uses the deep learning model using neural network 802, model monitoring 804 and the model fine tuning 410 to generate model output. The model output is then fed to the guidelines and simulation module 508. The guidelines module 508 uses model specific guidelines 806, manual GUI workbench 808 and automated guidelines 810 to define and generate one or more control functions. The decision generator module is fed to Arya-xAI module 510 to generate local and global explanations. The model specific guidelines 806 uses local explanations derived from the Arya-xAI 510. The model fine tuning 410 also uses feedback module 414 output and the Arya-xAI 510 output.

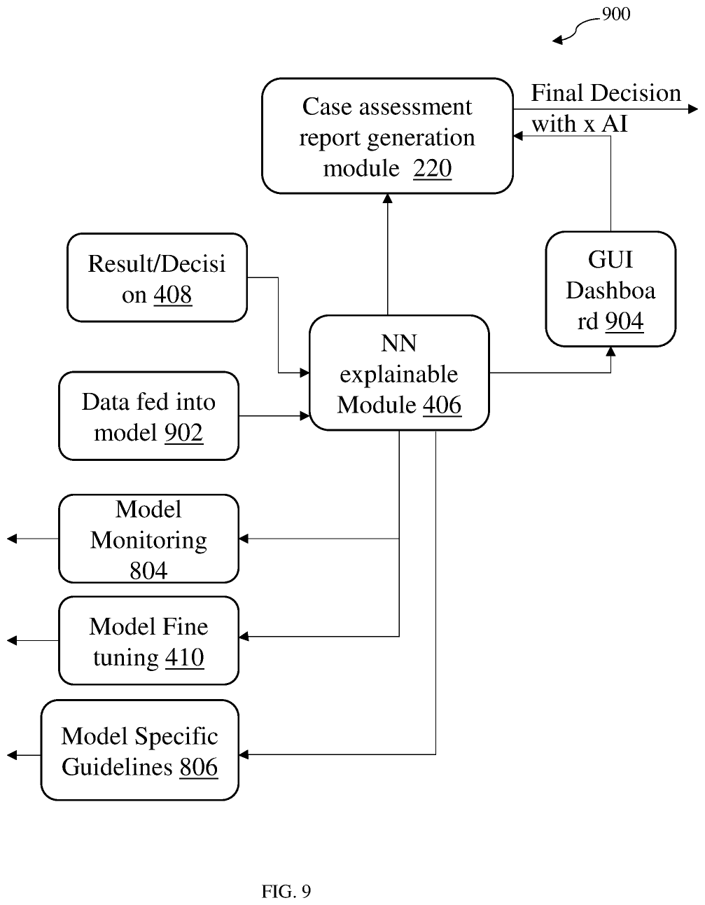

FIG. 9 is a block diagram 900 illustrating a Neural network explainable module 406 and a case assessment report generation module 220, such as those shown in FIG. 5, in accordance with an embodiment of the present disclosure. The result or decision 408 from the decision generator module 404 and data fed into the AI model 902 is fed into the neural network explainable module 406 for explanations and result validation. The data is the finalized case data for claim/underwriting. The output of the neural network explainable module 406 is fed into the case assessment report generation module 220 and a graphical user interface (GUI) dashboard 904. The output of the neural network explainable module 406 is also fed into the model monitoring 804, model fine tuning 410 and model specific guidelines 806 as shown in FIG. 8. The output of the GUI dashboard 904 is fed into the case assessment report generation module 220. The final decision, which is the output of the case assessment report generation module 220 is shared as the system output to the user.

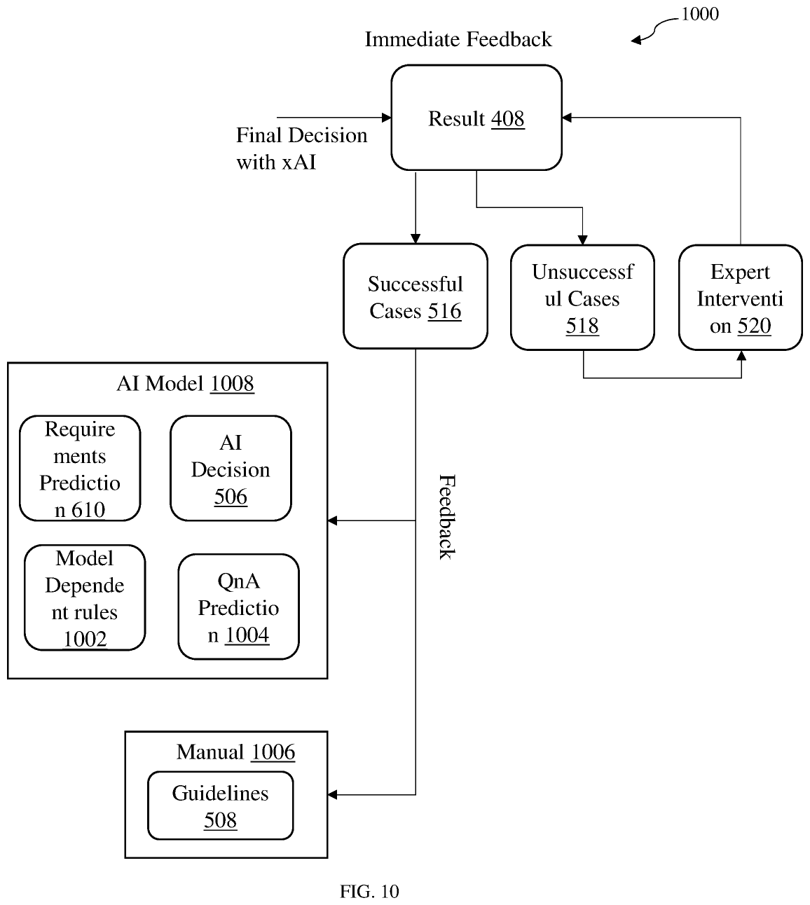

FIG. 10 is a block diagram illustrating a feedback module 414, such as those shown in FIG. 4 and FIG. 5, in accordance with an embodiment of the present disclosure. The final decision from the case assessment report generation module 220 is fed as the result 408. This result 408 may be classified as successful case 516 or unsuccessful case 518. In case of the unsuccessful case 518, an expert intervention 520 is sought and the result 408 is further classified as successful case 516 or unsuccessful case 518. In case of successful case 516, the feedback is given to the AI model 1008 and the manual module 1006. The AI model 1008 comprises requirements prediction model 610, AI decision model 506, model dependent rules 1002, and question and answer (QnA) prediction model 1004. The manual module 1006 comprises guidelines 508.

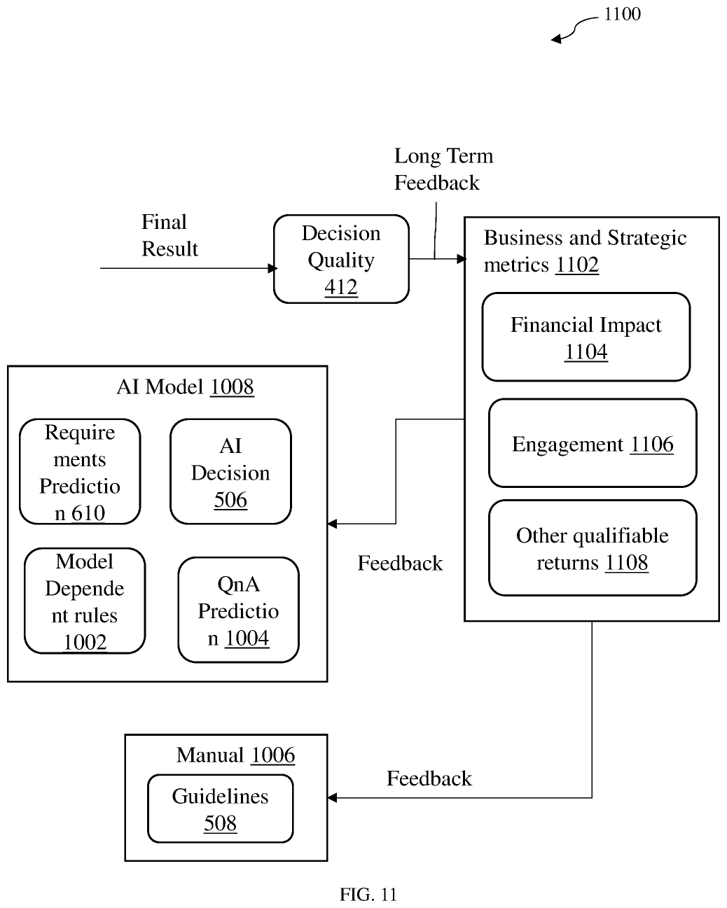

FIG. 11 is a block diagram illustrating a feedback module 414, such as those shown in FIG. 4 and FIG. 5, in accordance with another embodiment of the present disclosure. The final result is fed into the decision quality check module 412, whose inputs is received from business and strategic metrics 1102. The business and strategic metrics 1102 comprises financial impact 1104, engagement 1104, and other qualifiable returns 1108. Feedback is collected from the business and strategic metrics 1102 and fed to the AI models 1008 and the manual module 1006 for feedback, such as those shown in FIG. 10.

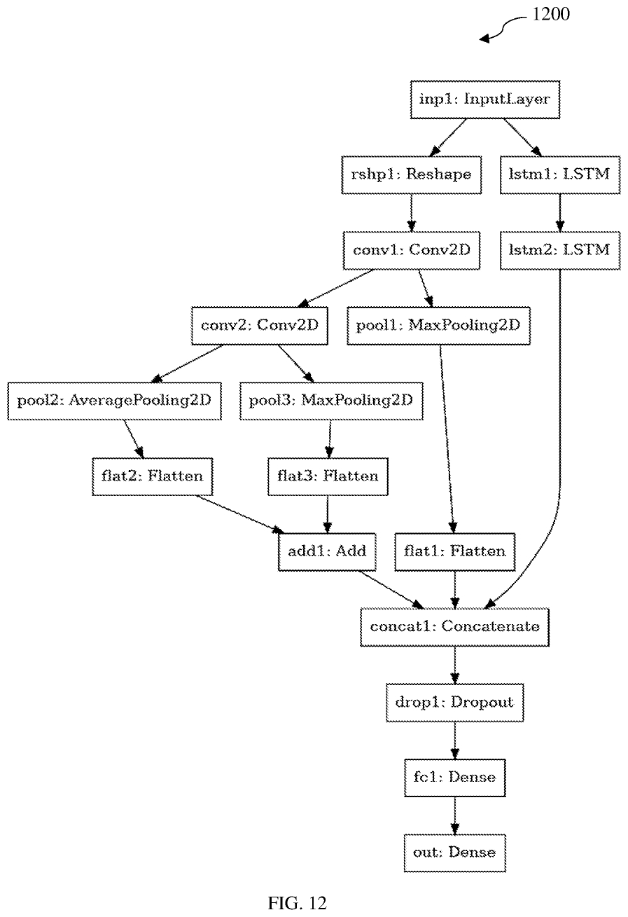

FIG. 12 is a schematic representation of an exemplary neural network 1200, in accordance with an embodiment of the present disclosure. An exemplary neural network 1200 comprising output neural nodes and input neural nodes and multiple neural layers is depicted.

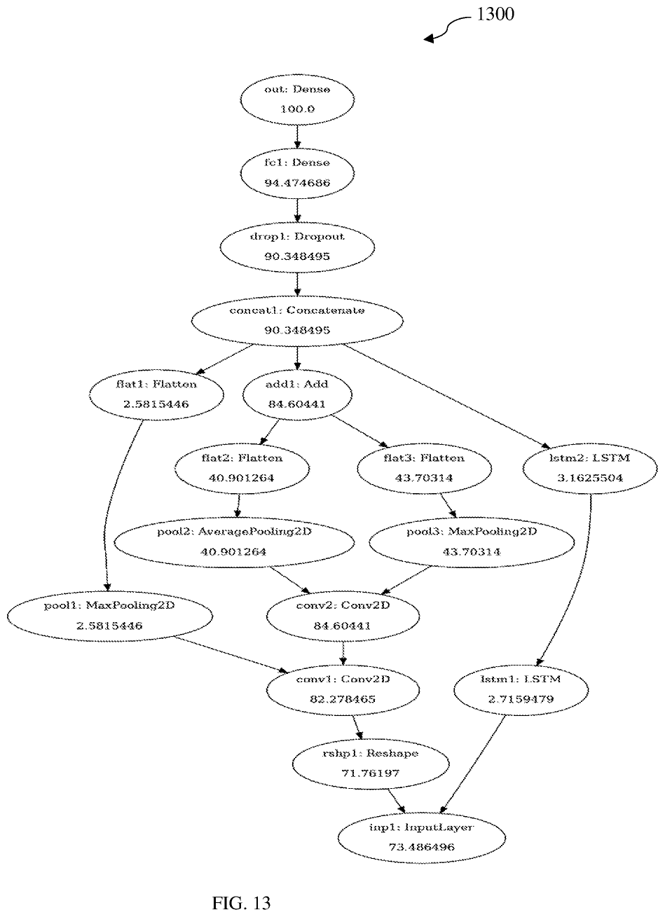

FIG. 13 is a schematic representation of an exemplary neural network explainable module output 1300, in accordance with an embodiment of the present disclosure. An exemplary back trace output 1300 comprising importance weights distributed across the neural network model is depicted. The neural network explainable module output 1300 is the validation output of the generated decision. Such back trace output 1300 is derived by first assigning an overall score to the generated decision, then assigning importance weightage to each of the neural node within the neural network model by propagating in a backward direction starting from final neural layer to first neural layer of the neural network model; wherein the importance weightage are proportionately distributed among one or more child nodes of the neural node and internal biases; determining whether the assignment of the importance weightage is completed to all of the neural nodes within the neural network model; determining a neural node importance weightage for each of the assigned importance weightage of the neural node, wherein the neural node importance weightage indicates impact of each of the neural nodes on arriving at the decision; computing aggregate weightage by summing each of the assigned importance weightage assigned to each of the neural node within the neural network; and correlating the aggregated importance weightage with the request indicating usage of the application information of the applicant, the financial information, health information, the activity information, and the sourcing information on arriving at the final decision.

Various embodiments of the present system provide a technical solution to the problem of providing explainable artificial intelligence based decisioning management method and system for processing financial transaction. The present system addresses multiple block that needs for a semi or fully autonomous engine that guides the application from the sourcing to decision making. The present system provides new controls and ways to define functional guidelines for the present system to prevent from any large errors. The present system provides fully explainable reasons including feature wise details on how the system arrived at the decision.

The present system described above has the following advantages. Firstly, the present system has no dependence on a sample selection algorithm. The importance weightage is calculated using the data sample in focus. This avoids deviations in importance weightage due to varying trends in sample datasets. Secondly, the present system has no dependence on a secondary white-box algorithm. The importance weightage is calculated directly from the network itself. This prevents any variation in importance weightage due to type, hyperparameters and assumptions of secondary algorithms. Thirdly, the present system is deterministic in nature. The neural node importance weightages does not change on repeated calculations on the same sample. Lastly, the present system are used in live environments or training workflows as a result of its independence from external factors.

Further, the present system is applicable in interpreting the model decisions using the local and global importance weightage of each feature. The local importance weightage is directly inferred from the importance weightage associated with input neural layers. For inferring global importance, the local importance weightage of each sample is normalized with respect to the model decision of that sample. The normalized local importance weightage from all samples are then averaged to provide global importance. The averaging can be further graded based on the various decisions and binding of the model decision. Further, the present system is applicable in network analysis based on the importance weightage attributed to each neural layer in the neural network. The two modes together provide huge information for each neural layer, such as: bias to input ratio, activation saturation, and positive and negative importance weightage (unit-wise and complete neural layer). Using this information, the neural layers may be modified to increase or decrease variability and reduce network bias. Major changes to the neural network architecture via complete shutdown of neural nodes or pathways are also possible based on the total contribution of that component.

In the present system, the dependence of final prediction on each input source are quantified as each input source neural layer is being assigned a fraction of the overall score. Also, such dependence is evaluated within the input source neural layer as the importance weightage assignment happens on per unit basis. Furthermore, instead of relying on the final prediction score for decision, the validity of the decision is determined based on the importance weightage distribution of any particular neural node with respect to the prior distribution of correct and incorrect predictions.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that are issued on an application based here on. Accordingly, the embodiments of the present invention are intended to be illustrative, but not limiting, of the scope of the invention, which is set forth in the following claims.

1. An explainable artificial intelligence based decisioning management system for processing financial transaction comprising:
one or more hardware processors; and
a memory coupled to the one or more hardware processors, wherein the memory comprises a plurality of modules in the form of programmable instructions executable by the one or more hardware processors, wherein the plurality of modules comprises:
a request handler module configured for receiving a request for performing a financial transaction from an applicant and from one or more data sources, wherein the request comprises application information of the applicant, financial information, health information, activity information, and sourcing information;
a data sufficiency validation module configured for performing a data sufficiency check using one or more neural networks on the received request by validating the request with trained neural network models;
a decision generator module configured for generating a decision for the received request using a neural network model if the data sufficiency check is successful, wherein the decision comprises at least one of an acceptance decision of the request, customization decision and a rejection decision of the request, wherein the neural network model comprises one or more neural layers comprising neural nodes representing an analysis of the application information of the applicant and wherein each of the neural nodes are assigned a weightage;
a neural network explainable module configured for validating the generated decision by reverse calculating, through the one or more neural layers of the neural network model, the importance weightage distribution across each of the neural nodes towards data features considered in the one or more neural networks; and
a case assessment report generation module configured for generating a case assessment report for the generated decision based on the validation, wherein the case assessment report comprises explainable reasons for arriving at the decision by the neural network model, impact of each of the neural nodes on arriving at the decision and similar past transactions; and
a financial transaction performer module configured for performing the financial transaction with the applicant in response to the received request based on the generated case assessment report.

2. The explainable artificial intelligence based decisioning system as claimed in claim 1, wherein in receiving the request for performing the financial transaction from the applicant and from the one or more data sources, the request handler module is configured for:
prompting one or more questions relating to the application information of the applicant; and
receiving additional application information of the applicant as a response to the one or more questions.

3. The explainable artificial intelligence based decisioning system as claimed in claim 1, wherein in generating the decision for the received request using the neural network model if the data sufficiency check is successful, the decision generator module is configured for:
generating one or more data features from the application information of the applicant;
applying the generated one or more features onto a trained neural network model, wherein the trained neural network model comprises the one or more neural layers comprising the neural nodes representing the analysis of the application information of the applicant and wherein each of the neural nodes are assigned the weightage on the basis of training on past transactions;
determining whether the output of the trained neural network model meets acceptance criteria prestored in the database; and
generating the decision for the received request based on the output of the trained neural network model and based on the determination.

4. The explainable artificial intelligence based decisioning system as claimed in claim 1, wherein in validating the generated decision by reverse calculating, through the one or more neural layers of the neural network model, the importance weightage distribution across each of the neural nodes, the neural network explainable module is configured for:
assigning an overall score to the generated decision;
assigning importance weightage to each of the neural node within the neural network model by propagating in a backward direction starting from final neural layer to first neural layer of the neural network model; wherein the importance weightage are proportionately distributed among one or more child nodes of the neural node and internal biases;
determining whether the assignment of the importance weightage is completed to all of the neural nodes within the neural network model;
determining a neural node importance weightage for each of the assigned importance weightage of the neural node, wherein the neural node importance weightage indicates impact of each of the neural nodes on arriving at the decision;
computing aggregate importance weightage by summing each of the assigned importance weightage assigned initially to each of the neural node within the neural layer until data features considered in the neural network; and
correlating the aggregated importance weightage with the request indicating usage of the application information of the applicant, financial information, health information, activity information, and sourcing information on arriving at the final decision.

5. The explainable artificial intelligence based decisioning system as claimed in claim 1, wherein in generating the case assessment report for the generated decision based on the validation, the case assessment report generation module is configured for:
mapping one or more data features associated with the application information of the applicant with corresponding set of explainable reasons for arriving at a decision pre-stored in a database;
prioritizing each of the set of explainable reasons based on descending order of the neural node importance weightage for each of the data features;
selecting at least one among the set of explainable reasons having descending order of priority based on the assigned importance weightage to each of the neural node along with aggregate of the assigned importance weightage to respective data feature; and
generating the case assessment report for the generated decision comprising the selected at least one explainable reason, the importance weightage of each data feature considered, impact of each the neural nodes on arriving at the decision and similar transactions from the past transactions.

6. The explainable artificial intelligence based decisioning system as claimed in claim 1, wherein in generating the case assessment report for the generated decision based on the validation, the case assessment report generation module is configured for:
retrieving the similar past transactions from training datasets using the importance weightage; and
generating the case assessment report for the generated decision comprising the retrieved similar past transactions

7. The explainable artificial intelligence based decisioning system as claimed in claim 1, further comprising a guideline generation and simulation module configured for:
defining one or more control functions corresponding to each of the data features within the neural network model; and
simulating the defined one or more control functions in a simulation environment, wherein the simulation environment emulates the neural network model, and the simulation environment is created based on applicant preferences.

8. The explainable artificial intelligence based decisioning system as claimed in claim 1, wherein the decision generator module is configured for:
collecting feedback for the generated decision from cases where decisioning is unsuccessful, cases where system errors are made, and cases where the financial transaction requests are processed successfully; and
updating the collected feedback as learning in a database.

9. The explainable artificial intelligence based decisioning system as claimed in claim 1, wherein the decision generator module is further configured for:
automatically triggering a model retraining process for the neural network model or at predefined time or data intervals on basis of criteria defined by the user on model drift, wherein the model retraining process generates revised hyper and network parameters for the neural network model;
validating the neural network model by simulating the neural network model in a test environment; and
updating the neural network model with the revised hyper and network parameters if the simulation is successful.

10. The explainable artificial intelligence based decisioning system as claimed in claim 1, wherein the financial transaction comprises loan, policy issuance, benefit qualification, insurance claim.

11. The explainable artificial intelligence based decisioning system as claimed in claim 1, wherein the neural network explainable module is further configured for:
determine performance of the trained neural network models based on the one or more financial transactions during a training stage; and
perform one or more tasks associated with the trained neural network model based on the determined performance of the trained neural network models.

12. The explainable artificial intelligence based decisioning system as claimed in claim 1, wherein the case assessment report generation module is further configured for:
generating alert messages indicating at least one of: possible model drifts and data drift based on the calculated importance weightage; and
transmitting the generated alert messages to the one or more end users.

13. An explainable artificial intelligence based decisioning management method for processing financial transaction comprising:
receiving, by a hardware processor, a request for performing a financial transaction from an applicant and from one or more data sources, wherein the request comprises application information of the applicant, financial information, health information, activity information, and sourcing information;
performing, by the hardware processor, a data sufficiency check using one or more neural network on the received request by validating the request with trained neural network models;
generating, by the hardware processor, a decision for the received request using a neural network model if the data sufficiency check is successful, wherein the decision comprises at least one of an acceptance decision of the request, customization decision and a rejection decision of the request, wherein the neural network model comprises one or more neural layers comprising neural nodes representing an analysis of the application information of the applicant and wherein each of the neural nodes are assigned a weightage;
validating, by the hardware processor, the generated decision by reverse calculating, through the one or more neural layers of the neural network model, the importance weightage distribution across each of the neural nodes towards data features considered in the one or more neural networks;
generating, by the hardware processor, a case assessment report for the generated decision based on the validation, wherein the case assessment report comprises explainable reasons for arriving at the decision by the neural network model, impact of each of the neural nodes on arriving at the decision and similar past transactions; and
performing, by the hardware processor, the financial transaction with the applicant in response to the received request based on the generated case assessment report.

14. The explainable artificial intelligence based decisioning method as claimed in claim 13, wherein receiving the request for performing the financial transaction from the applicant and from the one or more data sources comprises:
prompting one or more questions relating to the application information of the applicant; and
receiving additional application information of the applicant as a response to the one or more questions.

15. The explainable artificial intelligence based decisioning method as claimed in claim 13, further comprising:
defining one or more control functions corresponding to each of the data features within the neural network model; and
simulating the defined one or more control functions in a simulation environment, wherein the simulation environment emulates the neural network model, and the simulation environment is created based on applicant preferences.

16. The explainable artificial intelligence based decisioning method as claimed in claim 13, wherein generating the decision for the received request using the neural network model if the data sufficiency check is successful comprises:
generating one or more data features from the application information of the applicant;
applying the generated one or more features onto a trained neural network model, wherein the trained neural network model comprises the one or more neural layers comprising the neural nodes representing the analysis of the application information of the applicant and wherein each of the neural nodes are assigned the weightage on the basis of training on past transactions;
determining whether the output of the trained neural network model meets acceptance criteria prestored in the database; and
generating the decision for the received request based on the output of the trained neural network model and based on the determination.

17. The explainable artificial intelligence based decisioning method as claimed in claim 13, wherein validating the generated decision by reverse calculating, through the one or more neural layers of the neural network model, the importance weightage distribution across each of the neural nodes comprises:
assigning an overall score to the generated decision;
assigning importance weightage to each of the neural node within the neural network model by propagating in a backward direction starting from final neural layer to first neural layer of the neural network model; wherein the importance weightage are proportionately distributed among one or more child nodes of the neural node and internal biases;
determining whether the assignment of the importance weightage is completed to all of the neural nodes within the neural network model;
determining a neural node importance weightage for each of the assigned importance weightage of the neural node, wherein the neural node importance weightage indicates impact of each of the neural nodes on arriving at the decision;
computing aggregate importance weightage by summing each of the assigned importance weightage assigned initially to each of the neural node within the neural layer until data features considered in the neural network; and
correlating the aggregated importance weightage with the request indicating usage of the application information of the applicant, financial information, health information, activity information, and sourcing information on arriving at the final decision.

18. The explainable artificial intelligence based decisioning method as claimed in claim 13, wherein generating the case assessment report for the generated decision based on the validation comprises:
mapping one or more data features associated with the application information of the applicant with corresponding set of explainable reasons for arriving at a decision pre-stored in a database;
prioritizing each of the set of explainable reasons based on descending order of the neural node importance weightage for each of the data features;
selecting at least one among the set of explainable reasons having descending order of priority based on the assigned importance weightage to each of the neural node along with aggregate of the assigned importance weightage to respective data feature; and
generating the case assessment report for the generated decision comprising the selected at least one explainable reason, importance weightage of each data features considered, impact of each the neural nodes on arriving at the decision and similar transactions from the past transactions.

19. The explainable artificial intelligence based decisioning method as claimed in claim 13, further comprising:
automatically triggering a model retraining process for the neural network model or at predefined time or data intervals on basis of criteria defined by the user on model drift, wherein the model retraining process generates revised hyper and network parameters for the neural network model;
validating the neural network model by simulating the neural network model in a test environment; and
updating the neural network model with the revised hyper and network parameters if the simulation is successful.

20. The explainable artificial intelligence based decisioning method as claimed in claim 13, wherein the financial transaction comprises loan, policy issuance, benefit qualification, insurance claim.

21. The explainable artificial intelligence based decisioning method as claimed in claim 13, further comprising:
collecting feedback for the generated decision from cases where decisioning is unsuccessful, cases where system errors are made, and cases where the financial transaction requests are processed successfully; and
updating the collected feedback as learning in a database.

22. The explainable artificial intelligence based decisioning method as claimed in claim 13, further comprising:
determine performance of the trained neural network models based on the one or more financial transactions during a training stage; and
perform one or more tasks associated with the trained neural network model based on the determined performance of the trained neural network models.

23. The explainable artificial intelligence based decisioning method as claimed in claim 13, further comprising:
generating alert messages indicating at least one of: possible model drifts and data drifts based on the calculated importance weightage; and
transmitting the generated alert messages to the one or more end users.
